(19) United States
(12) Patent Application Publication
(10) Pub. No.: US 2023/0173894 A1
(43) Pub. Date: Jun. 8, 2023

(54) WINDSHIELD FOR VEHICLE

(71) Applicant: International Truck Intellectual Property Company, Lisle, IL (US)

(72) Inventors: Michael KRUEGER, OSWEGO, IL (US); Aditya RAJDERKAR, Hoffman Estates, IL (US); Robert Paul SCOTT, Aurora, IL (US)

(73) Assignee: International Truck Intellectual Property Company, LLC, Lisle, IL (US)

(21) Appl. No.: 17/541,892

(22) Filed: Dec. 3, 2021

(51) Int. Cl. B60J 1/00

(52) U.S. Cl. CPC B60J 1/004

(57) ABSTRACT

A windshield comprises first and second sections of transparent material each having a perimeter disposed adjacently on an aperture on a vehicle. Encapsulation is included with the sections of transparent material disposed adjacent the perimeters. A member is included on the encapsulation adjacent the first section extending from the encapsulation disposed adjacent the perimeter of the first section of transparent material to the encapsulation adjacent the second perimeter of the second section.

### BACKGROUND

This current disclosure relates generally to disposing a transparent member on a vehicle. More specifically, this disclosure relates to a vehicle, such as a bus and the like, windshield.

Some currently available windshields are held in place on a vehicle by a seal located between a perimeter of the windshield and an opening on the vehicle. This seal may not have desired durability, leak reduction and other properties. These property deficiencies may lead to water or gas entering the vehicle. The entered water can damage the vehicle. Gas entering the vehicle may reduce vehicle aerodynamics thereby given the vehicle lower fuel efficiency.

It is desired to provide an improved windshield for a vehicle. A vehicle with such an improved windshield may experience increased durability, and increased fuel economy.

### SUMMARY

This disclosure relates to embodiments of a windshield for a vehicle. According to one embodiment, a windshield comprises first and second sections of transparent material each having a perimeter disposed adjacently on an aperture on a vehicle. Encapsulation is included with the sections of transparent material disposed adjacent the perimeters. A member is included on the encapsulation adjacent the first section extending from the encapsulation disposed adjacent the perimeter of the first section of transparent material to the encapsulation adjacent the second perimeter of the second section.

### DESCRIPTION OF THE DRAWINGS

FIG. 1 is a perspective view of a portion of a windshield disclosed herein;

FIG. 2 is a sectional view taken along line 2-2 of FIG. 1; and

FIG. 3 is a perspective view of a portion, opposite to the portion of the windshield of FIG. 1, of the windshield disclosed herein.

### DETAILED DESCRIPTION

This disclosure relates generally to disposing a transparent member on a vehicle. More specifically, this disclosure relates to windshield for a vehicle, such as a bus and the like.

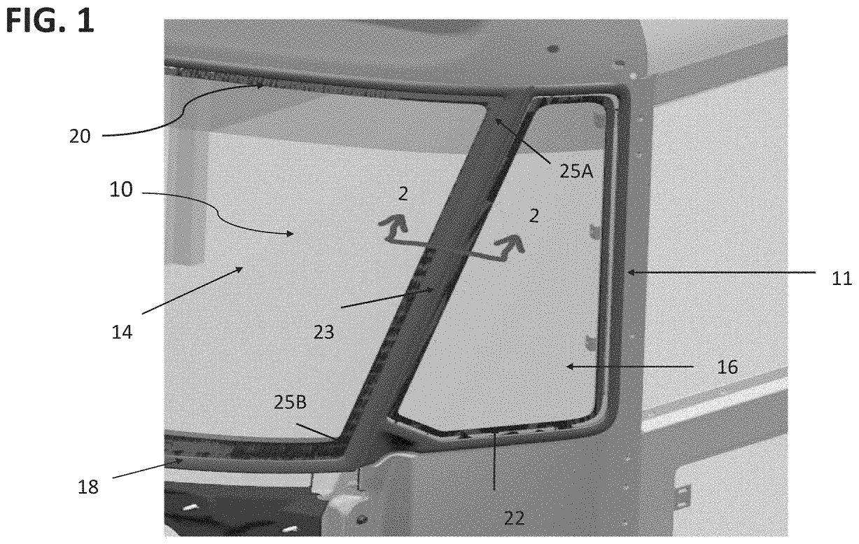

One embodiment of a windshield 10 disposed on an aperture 11 on a vehicle 12 is shown in FIG. 1. The windshield 10 may comprise a first section 14 of transparent material and a second section 16 of transparent material located adjacent the first section 14 of transparent material. The windshield 10 may comprise as many sections as needed to occupy the aperture 11. The first section 14 and the second section 16 comprise a transparent material, such as safety glass and the like, appropriate for the vehicle 12. For example, if the vehicle 12 is a school bus, the transparent material may be a laminated glass or other glass formulation specified by an authority, such as a school board, a municipality and the like.

The first section 14 and the second section 16 include encapsulation 18 disposed adjacent a first perimeter 20 of the first section 14 and a second perimeter 22 of the second section 16. The encapsulation 18 may be substantially similar to an item commonly disposed around glass. Depending on the embodiment, the encapsulation 18 may comprise one or more portions. In one embodiment, the encapsulation 18 comprises a polymer, such as a molded plastic and the like, often used in a vehicle application. The encapsulation 18 may be located adjacent an interface among the aperture 11, the vehicle 12, the first section 14 and the second section 16 to increase aerodynamics of the vehicle 12 as well as to reduce entry of other material, such as water and the like, into the vehicle 12.

In some embodiments, the encapsulation 18 may include a trough 23 extending along a segment of the encapsulation 18. For instance, the trough 23 may extend between a first position 25A on the encapsulation 18 to a second position 25B on the encapsulation 18 to direct a substance, such as water and the like, along the trough 23 on the encapsulation 18 thereby encouraging the substance to move away from the windshield 10.

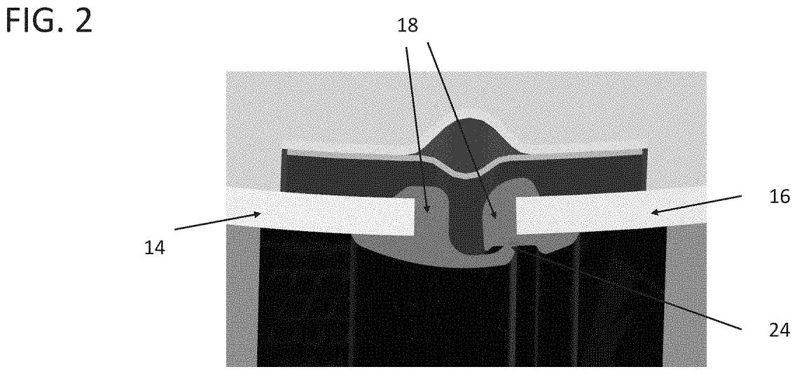

As shown in FIG. 2, encapsulation 18 adjacent the first section 14 includes a member 24 that extends from encapsulation 18 adjacent the first section 16 to encapsulation 18 adjacent the second section 16. In this manner, the member 24 can provide closure of a space between portions of the first section 14 and the second section 16, thereby accommodating variance in dimensions of the first section 14 and the second section 16, reducing entry of material, such as water and the like, into the vehicle 12, increasing aerodynamic nature of the vehicle 12 and improving vehicle 12 aesthetics.

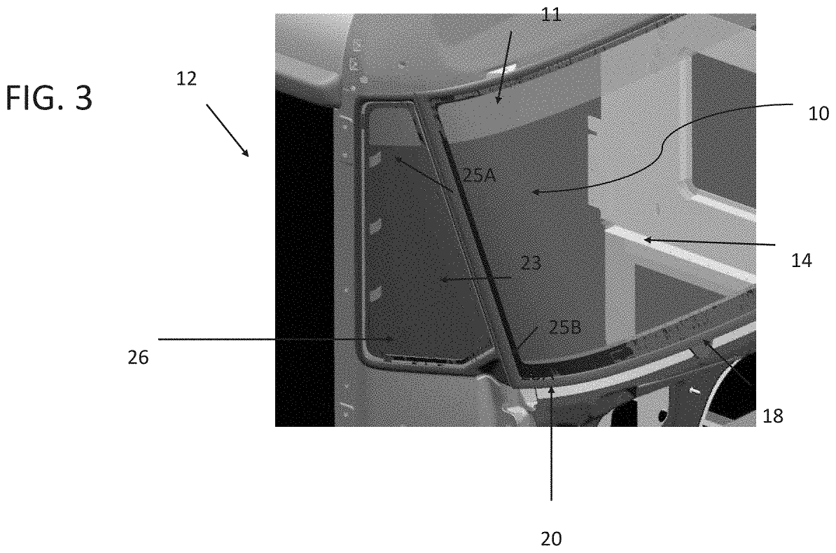

FIG. 3 shows a third section 26 of transparent material of the windshield 10. The third section 26 is substantially similar to the second section 16. The third section 26 is disposed at an end of the first section14 opposite to an end of the first section 14 adjacent the second section 16. Depending on the particular embodiment of the windshield 10, the third section 26 may be eliminated.

What is claimed is:

1. A windshield for vehicle disposed on an aperture on the vehicle, the windshield comprising:
a first section of transparent material disposed on the aperture on the vehicle, the first section having a first perimeter;
a second section of transparent material disposed on the aperture of the vehicle, the second section having a second perimeter, the second section of transparent material located adjacent the first section of transparent material;
encapsulation included with the first section of transparent material, the encapsulation disposed adjacent the first perimeter;
the encapsulation included with the second section of transparent material, the encapsulation disposed adjacent the second perimeter; and
a member included on the encapsulation adjacent the first section of transparent material extending from the encapsulation disposed adjacent the first perimeter of the first section of transparent material to the encapsulation adjacent the second perimeter of the second section.

2. The windshield of claim 1 further comprising:
a third section of transparent material disposed at an end of the first section of transparent material opposite to an end of the first section of transparent material adjacent the second section of transparent material.

3. The windshield of claim 1 further comprising:
a trough extending along the encapsulation.

4. The windshield of claim 1 further comprising:
a member extending from the encapsulation adjacent the first section of transparent material to the encapsulation adjacent the second section of transparent material.
